(19) United States
(12) Patent Application Publication
(10) Pub. No.: US 2006/0150852 A1
(43) Pub. Date: Jul. 13, 2006

(54) Pre-register adjustment

(76) Inventor: Manfred Loddenkoetter, Ibbenbueren (DE)

Correspondence Address: JACOBSON HOLMAN PLLC, 400 SEVENTH STREET N.W., SUITE 600, WASHINGTON, DC, 20004, US

(21) Appl. No.: 10/535,910

(22) PCT Filed: Nov. 12, 2003
(86) PCT No.: PCT/EP03/12865

§ 371 Date: Jan. 27, 2006

(30) Foreign Application Priority Data
Nov. 22, 2002 (DE) 102 54 836.6

(51) Int. Cl. B41F 1/34

(52) U.S. Cl. 101/485

(57) ABSTRACT

Described is a method for pre-registration in a printing machine (1) with multiple printing units (D1-D4). In this method, the phases of the printing cylinders (F1-F4) involved in the printing process are so mutually attuned that the deviations of the printing images of the different printing cylinders (F1-F4) lie within mutual capture areas, which are used in context of the registration of an ongoing printing operation, respectively, for the determination of the position of the printing images or parts thereof.

New and inventive is that the web (4) to be printed, which is fed during the pre-registration to the printing machine (1), has at least one mark, which passes through different printing units during the pre-registration, whereby the time points, at which the mark passes the measuring points in the printing units, are recorded, these time points are set with reference to the angular position of the printing images of the respective printing units (D1-D4) at those time points.

The invention relates to a process for pre-register setting according to the preamble of claim 1.

For multicolor printing, printing machines—and here in particular, gravure printing machines—apply individual colors in individual printing units. In the printing process, the positions of the images with the different colors with respect to each other are checked by means of register controls. For that purpose, the register marks are in general recorded and their distances are kept constant.

This type of register methods are discussed, among others, in the hitherto unpublished German patent application with the application number 102 54 836.

Before the printing process starts, and before these controls are used, the printed images must be mutually so aligned that the register marks lie within the capture area of the used measuring system of the regulator (pre-register setting). For that, the phasing of the cylinder and/or the web length between the printing units is adjusted. The effective sheet length of the webs between the printing units is in general not an integral multiple of the printing length.

As a rule, the pre-registering takes place during the preparation of the press. The printing length varies according to the motif and the anticipated web extensions. The effective web length between the printing units varies due to the selected path of the web, due to the different sizes of the printing cylinders and the impression roller, due to the mechanical flexibility and the tolerances, due to process parameters like the web tension and the drying temperature, as well as due to physical properties of the printing material, such as its modulus of elasticity and its geometrical dimensions.

The pre-register setting is done according to the state of the art for the printing job, for which the preparations are done for the first time, in general manually. The print images are printed at random positions on the web. In stationary machines, the position deviation is then determined through length measures. This data is entered as correction values in the machine regulation, which determines and sets the phase displacement based on it. In a reapplied contact pressure, the printed images then overlap to a large extent. The required time and the quantity of the discards are a disadvantage in this method.

Automated pre-register settings require entry of the web length as the basis for the calculations for the phase of the cylinder in the preparations for the first time. However, the effective web length varies much, especially in case of flexible printing substrates, due to the variations in the length of the material, so that the capture area is in general missed and the process is therefore employed only seldom. Thereby, the tolerance in the alignment of the printing cylinder with the rotation angle receiver of the drive also proves to be problematic.

A pre-register setting for a repetitive application can be based on stored information about the phasing of the printing cylinder for the original application. However, this process requires otherwise also exact repetition of all process and machine parameters (even the ambient temperature and the humidity) and has consequently been less successful in general.

Thus, the object of the present invention is to propose a more successful pre-register process that is capable of fast performance.

This problem is solved according to the characterizing part of aforesaid claim 1.

In a preferred embodiment of the process according to the invention, the phasing of the cylinder undergoes automatic mutual adjustment. For that purpose, the web is marked before the first printing unit. The marks go along with the web, under any arbitrary process conditions, in course of the printing operation through all printing units, which have random phasing. The mark is identified by the position in each printing unit and the phasing of the associated printing cylinder is determined in isochronous manner.

The first cylinder forms the desired phase of the print mark, other cylinders show deviating phases at the time of the arrival of the mark. Through lifting of the impression cylinder for a short moment with immediate phase adjustment of the cylinder according to the detected phase deviation, and its lowering again, the print images superimpose after the passage of the mark.

However, it is also conceivable to first save the information about the relative angular position of the printing cylinder for marking the web, gained by means of the method according to the invention, and to carry out the necessary settings for the pre-registration at a later point of time.

The mark is preferably an adhesive strip, which acts as a change in the web thickness at the print clearance between the printing cylinder and the impression roller and disturbs the transport of the web and the rotation of the print cylinder. This type of discontinuity/bulge leads in general to a change in the speed of the drive chain of the individually driven printing cylinders and as a result to deviation of the actual position from the desired position of the cylinder (lag error). Feedback circuits in the modern drives (with current, speed and position regulation circuits) compensate for this deviation through increase in the motor current, which leads to a higher driving torque. Thus, the measured variables, namely, the lag errors, position, speed, acceleration, motor current and torque at the time of the arrival of the mark at the printing clearance are characterized by a change in their sizes. An additional sensor is not necessary. Indirectly measured variables can be calculated.

The higher the pressure of the impression cylinder and the thicker, wider and harder the adhesive stripe, greater are the jumps in the measured variables. Due to the changes in the parameters of the drive control circuits, not only large torque jumps, but also large lag errors, can be the result.

Basically, an adhesive stripe can also be an adhesive joint between two webs.

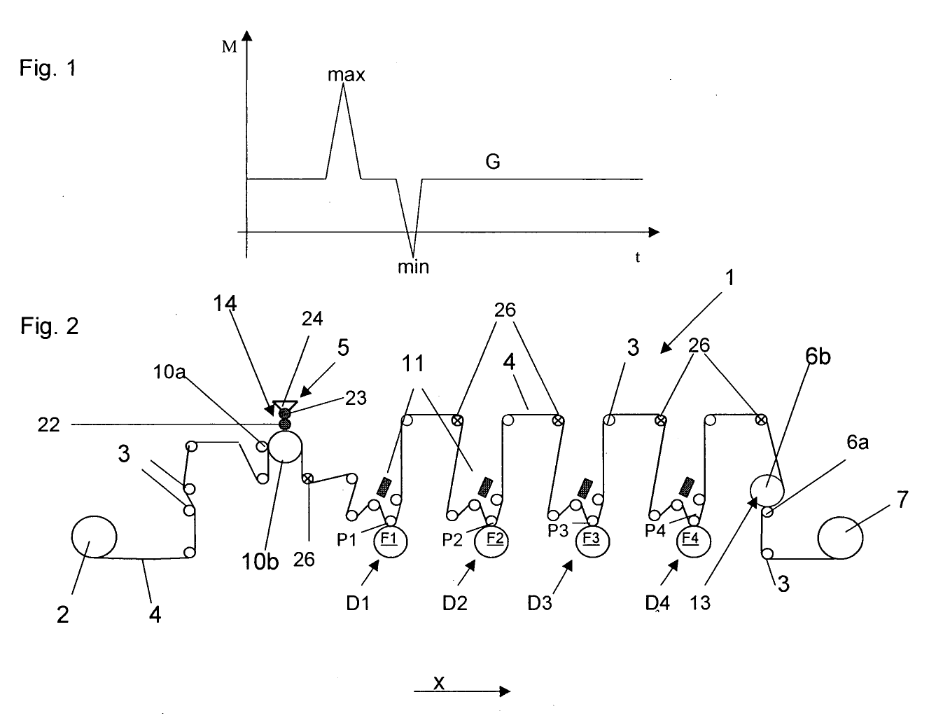

The passage of an adhesive stripe through the printing clearance simply leads to a torque curve of the drive as shown in FIG. 1.

The first rise in the torque curve is suitable for the detection of the arrival of the mark as also the first maximum or the derived variables. Signal profiles in sequence of time are typically overlapped with transients.

The local resolution is determined through the quality of the signal rise and the scanning times of the drive feedback circuits, in combination with the speed of the webs.

The passage of such a mark (adhesive stripe/adhesive joint) can also be detected through a change in the tension of the web. This is particularly visible in case of solid printing substrates with high e-module. The lag error reduces the tension of the web for a short duration. In the run of the web, the rollers for measuring the web tension are integrated at diverse positions. In the modern machines, they are located at the front, rear and between the printing units.

If the requirements in regard to the positional accuracy and the speed of the web cannot be fulfilled adequately for an application, the mark can also be detected with an additional sensor.

The passage of a mark can be detected as follows:

The adhesive strip lifts the impression cylinder by about 1/10 mm.

A position encoder registers this alteration in the position (distance sensor, initiator, lag sensor, rotation angle transducer in differential gears . . . )

Besides the mechanical, optical and inductive sensors, let the possibility of capacitive detection be also mentioned here. For that, the change in the capacity between the earthed printing cylinder and the semi conducting impression cylinder (ESA) can be determined. An adapted adhesive mark can also lead to a change in the current or the voltage in the ESA circuit, which is then identified as the passage of the mark.

An acceleration sensor can detect the jerky lifting of the impression cylinder.

A pressure measurement device, which monitors the pressure of the impression cylinder, can detect the lifting of the impression cylinder.

An adhesive stripe on the backside of the printing material, which is in particular in color, is detectable with certainty also by a so-called color-sensor. Disadvantageous in a sensor mechanism outside the printing clearance are the errors in the assignment of the phases of the printing cylinder, for example, due to a different diameter of the impression cylinder. This error does not appear in case of the aforementioned process and is looked at as an advantage.

Further marks, like a perforation in the form of a hole in the web, are also thinkable in context of this application. Present web rupture sensors (optical/capacitive) or reflection sensors can also monitor these marks.

It is of particular advantage to use a method according to the invention for the rotogravure print and, there, in particular in the package rotogravure print, because, there are large web lengths between the individual color decks, which make the pre-registration especially complicated with the flexible materials frequently used in such cases.

Other illustrative instances of the embodiment according to the invention follow from the objective description and the claims.

The individual Figures show:

FIG. 1 The torque curve with the drive of a pressure roller and counter-impression cylinder during the passage of an embossed marking.

FIG. 2 A view of a gravure printing press

In FIG. 1, the graph G shows an exemplary profile of the torque M against time t.

The torque exerted by the drive forming, at least one of the two roller clearance drives, reaches its relative discrete maximum value max with the arrival of the embossed mark. When the marking leaves the roller clearance, a minimal torque is applied—the torque curve reaches its minimum.

FIG. 2 shows a sketch of a side view of a serial gravure printing press 1, which is provided with the pre-register settings according the invention. Shown are the four color decks F1 to F4, of which only the impression rollers P1 to P4, and the print rollers D1 to D4, are shown. As mentioned, the rotogravure press is equipped with an embodiment of the pre-register settings according to the invention. The exact design of the rotogravure press, not according to the invention, such as its equipment with only four color decks—which are inadequate for the modern package print—has only a exemplary character here.

During the printing process, the printing substrate 4 is unwound from the winding or the reserve roll 2 and is fed at first through the guide roll 3 to the draw unit 14, of which the 14, the press roller 10a and the drawing unit roller 10b are shown here in a stylized fashion. Besides that, the drawing unit 14 includes a drawing print unit 5, which is built in this case—for example—as a flexographic press. As a result, the format cylinder 22 and the engraved roller 23 and the doctor blade chamber 24 are shown as the constituents of the drawing press unit.

To carry out the processes according to the invention, however, other printing units, automatic or manual etiquette device or even punching devices are also suitable. Even the place at which this “pre-marking” is done in the web is also arbitrary.

The drawing press unit makes a web marking, not shown here, on the printing material web 4.

The material web 4 is fed through the sensor roller 26, which measures the sheet tension, and feeds the diverse guide rolls 3 to the printing units D1 to D4 and is printed on. Since it has to do in case of the shown printing machine 1 with a serial rotogravure press, in which the invention can be used especially well, these printing units D1 to D4 consist of impression cylinders P1 to P4 and format cylinders F1 to F4, which are also called print rollers for the purpose of this patent application. For the determination of the position of the marking, sensors 11 are installed before the respective color decks F1 to F4, in the direction of the transport of the printing material web 4. These sensors 11 transmit the time point to the counter unit, not shown here, at which the marking passes the respective sensed positions.

Other preferred instances of the embodiments according to the invention resort in this context to other sensors. Thus, among other things, compared to the printing material 4, the embossed markings can be detected more exactly, if these markings pass the roller clearance, where the printing process takes place. For that, the torque curve of the roller drives can be monitored. Of course, the action of the force of the marking on the rollers, or the position change resulting from the action of this force, can also be measured by means of appropriate sensors.

A counter unit determines according to the invention the difference between the angular positions of the various cylinders at this point of time, when at least one mark passes the corresponding printing unit. Following that, the correction signals are generated, which set the relative angular positions of the printing rollers and/or the web path between the different printing units. The latter can take place, in case of the shown machine for example, through alteration of the position of the guide rolls 3.

In case of FIG. 2, display of the shaft encoders or other position measuring devices is omitted, because it is known, for instance, how the more recent directly driven machines are equipped with these sensors.

For example, in DE 101 45 957 A1, a number of the actuating mechanisms and drives are described, which play a role in printing machines—in the named case, a central cylinder flexographic press. In the mentioned application, it is also described how the actuating elements can be connected with a regulating device. In modern directly driven machines, the drives are often directly networked with regulator devices, which include counter units. Therefore, at this point, the graphical presentation of the regulator and counter units as well as of their connection with the actuators of the printing machines can be dispensed with.

What remains to be mentioned, is that the printed printing material is fed, in the familiar manner, through the guide rolls 3 to the drawing unit 13, which consists of a contact pressure roller 6a and the drawing roller 6b. After that the printing material passes through the guide rolls 3 to the take-up 7, in which it winds up 4 and is stored.

In the present application, as the print clearance or the roller clearance, the clearance between any roller carrying a printed image and a counter-support is denoted. Thereby, let it be stressed, that a rubber blanket roller, which does not transport any printing plate, but only an impression of it, also carries a printing image in the sense of the present application. In illustrative embodiment shown in FIG. 2, the print clearance between the print rollers D1-D4 and the respective impression rollers P1-P4 are shown.

List of Reference Symbols

| | |
|---|---|
| 1 | Printing machine/press |
| 2 | Storage roll |
| 3 | Guide roll |
| 4 | Printing material web |
| 5 | Drawing printing unit |
| 6a | Pressure roller |
| 6b | Draw-in roller |
| 7 | Take-up |
| 10a | Pressure roller |
| 10b | Take-up |
| 11 | Sensor |
| 13 | Draw-in |
| 14 | Draw-in |
| 22 | Format cylinder |
| 23 | Engraved roller |
| 24 | Doctor blade chamber |
| 26 | Sensor roller |
| D1-D4 | Pressure units |
| F1-F4 | Format cylinder |
| P1-P4 | Impression cylinders |
| Max | Maximum |
| Min | Minimum |
| G | Graph |
| M | Torque |
| T | Time |

1. Process for the pre-registration in a printing machine (1) with multiple printing units (D1-D4),
in which the phases of the printing cylinders (F1-F4) involved in the printing process is so mutually attuned that,
the deviations of the printing images of the various printing cylinders (F1-F4) lie within the mutual capture area of the measuring system,
which is used in context of the registration during an ongoing printing operation respectively for the determination of the printing images or of the parts of the same,
characterized in that
the web (4) to be printed, which is fed to the printing machine (1) in the pre-registration, has at least one marking
which passes various printing units during the pre-registration
whereby the time points, at which the marks pass the measuring points in the printing units, are recorded, these time points are set with reference to the angular position of the printing images of the respective printing units (D1-D4) at these time points and
that based on this comparison, the drives of the printing cylinders (F1-F4) and/or the web path between the printing units are so adjusted
that the deviations of the printing images of the different printing cylinders (F1-F4) lie mutually within the capture area of the measuring system,
which are used in context of the registration during an ongoing printing operation respectively for the determination of the printing images or parts of the same.

2. Process according to claim 1,
characterized in that
the time points, at which the mark passes the measuring points in the printing units (D1-D4)
and/or the angular position of the printing image at these points of time
and/or the difference between the angular position of the different printing images at the time point, at which it passes at least one mark of the corresponding printing unit
is made visible with the help of a display device and
that a machine operator sets, based on the displayed information, the drives of the printing cylinder (F1-F4) and/or the path of the web between the printing units (D1-D4).

3. Process according to claim 2
characterized in that
the time points, at which the mark passes the measuring points in the printing units (D1-D4)
and/or the angular position of the printing images at that point of time
are made visible by means of a display device and
that a counter unit calculates the difference between the angular position of the different printing images at that time point, at which at least one mark passes the respective printing unit (D1-D4), and adjusts the drives of the printing cylinders (F1-F4) and/or the web path between the printing units (D1-D4).

4. Process according to one of the preceding claims,
characterized in that
the time points are recorded, at which the print mark passes the roller clearance.

5. Process according to one of the preceding claims
characterized in that
the mark, with which the web (4) to be printed is marked, is embossed, compared to the printing material, on at least one surface of the web (4).

6. Process according to claim 4 and 5
characterized in that
the action of the force, which is exercised during the passage of the mark through the roller clearance, on the printing cylinders (F1-F4) or its counter-support, or the change in the position or the acceleration of the print cylinders (F1-F4) and/or their counter-supports, or other derived mechanical parameters, are recorded.

7. Process according to claim 4 and 5 or 6
characterized in that
the change of the torque (M) is recorded, which a drive exerts on the roller adjacent to the print clearance, as the mark passes through the print clearance.

8. Process according to claim 7
characterized in that
for the recording of the torque change (M), the current of the drive which generates the torque of the printing cylinders (F1-F4), of the counter-supports (P1-P4), or another electrical quantity related to the current, such as voltage, is measured

9. Process according to claim 4 and 5 or 6
characterized in that
the lag error of the drive of the printing cylinder (F1-F4) or the counter-support (P1-P4) is monitored and, based on its course, the time point of the passage of the mark is determined.

10. Process according to one of the preceding claims
characterized in that
during the pre-registration, the printing machine (1) is loaded with a web (4) to be printed, which already carries a mark.

11. Printing machine
characterized in that
a pre-registration device for performing one of the processes according to one of the preceding claims.
